(19) United States
(12) Patent Application Publication
(10) Pub. No.: US 2014/0033586 A1
(43) Pub. Date: Feb. 6, 2014

(54) Display Kit

(71) Applicant: Plaid Enterprises, Inc., Norcross, GA (US)

(72) Inventor: Greg Myracle, Orange, VA (US)

(21) Appl. No.: 13/937,770

(22) Filed: Jul. 9, 2013

Related U.S. Application Data
(60) Provisional application No. 61/680,162, filed on Aug. 6, 2012.

(51) Int. Cl. G09F 19/00; G09F 23/00

(52) U.S. Cl. CPC G09F 19/00; G09F 23/00
USPC 40/538; 29/428

(57) ABSTRACT

A press character (100) includes a character portion (101) and a first post (102) and a second post (103). The first post and second post extend from opposite ends of the character portion. A user can place the first post into an edge (503) of a lobe (502) of an object, such as a pumpkin (500) or watermelon. Another lobe (501) can be applied to cause the second post (103) into another edge (504) of the another lobe to form a display.

### CROSS REFERENCE TO PRIOR APPLICATIONS

This application claims priority and benefit under 35 U.S.C. §119(e) from U.S. Provisional Application No. 61/680,162, filed Aug. 6, 2012, which is incorporated by reference for all purposes.

### BACKGROUND

1. Technical Field

This disclosure relates generally to displays, and more particularly to displays for pumpkins, watermelons, and other similar objects.

2. Background Art

Prior art pumpkin carving kits are traditionally messy and cumbersome to use. Many prior art pumpkin carving kits are sold as “single-use” items and can accordingly only be used one time. One of the biggest problems with prior art pumpkin carving kits is that they include sharp knives, saws, and other cutting instruments. Consequently, young children generally are not able to use them due to the fact that they are dangerous.

Illustrating by example, most prior art pumpkin carving kits, tools, or products include one or more saws, knives, or other sharp blades. A user is instructed to cut designs into the pumpkins using these saws, knives, and blades. The designs may be in accordance with a template included with the kit. Alternatively, they may be freehand. These sharp tools are dangerous. They are especially dangerous for younger users. Moreover, these prior art kits require a lot of time for proper designs to be created and result in a large mess when various parts and pieces are cut from the pumpkin. It would be advantageous to have an improved pumpkin decorating kit.

### BRIEF DESCRIPTION OF THE DRAWINGS

FIG. 1 illustrates a perspective view of one explanatory press character in accordance with one or more embodiments of the disclosure.

FIG. 2 illustrates an elevation view of one explanatory press character in accordance with one or more embodiments.

FIG. 3 illustrates an elevation view of another explanatory press character in accordance with one or more embodiments.

FIG. 4 illustrates an elevation view of yet another explanatory press character in accordance with one or more embodiments.

FIG. 5 illustrates part of an explanatory method of creating a pumpkin display in accordance with one or more embodiments.

FIG. 6 illustrates another part of an explanatory method of creating a pumpkin display in accordance with one or more embodiments.

FIG. 7 illustrates another part of an explanatory method of creating a pumpkin display in accordance with one or more embodiments.

FIG. 8 illustrates another part of an explanatory method of creating a pumpkin display in accordance with one or more embodiments.

FIG. 9 illustrates an explanatory pumpkin display in accordance with one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure provide solutions to the problems mentioned above, namely the fact that prior art pumpkin carving kits are messy, single use, and dangerous for small children. Embodiments of the disclosure provide simple, one-piece characters that press neatly into an object, such as a pumpkin, watermelon, or other object. Using a pumpkin as an explanatory object, embodiments of the disclosure are safer for children than are the knives, saws, and sharp instruments found in prior art pumpkin decorating kits. Embodiments of the disclosure offer a creative alternative for decorating a pumpkin, watermelon, or other object, and for creating a display. Embodiments of the disclosure allow users the opportunity to experience a “hands-on” approach to decorating a pumpkin, watermelon, or other object that all but eliminates the risk of being cut by bladed instruments.

With prior art designs, a user must use a knife or bladed instrument to cut an image in a pumpkin. When a light source is placed within the pumpkin, the holes cut in the pumpkin are illuminated. Embodiments of the disclosure provide completely different, unique, and novel devices and methods for decorating a pumpkin. In one embodiment, pre-manufactured three-dimensional characters have sharpened posts and, optionally, discs on either side to allow the characters to be attached to a pumpkin by pressing one of the posts into the pumpkin. The result is a safer, less messy, and quicker system. Moreover, embodiments of the disclosure are reusable and offer a user the ability to create custom pumpkin displays. Additionally, embodiments of the disclosure allow users to have a hand-on experience and interaction when decorating a pumpkin.

Embodiments of the disclosure advantageously save time when creating a pumpkin display. This is true because prior art carving kits require time to carve designs into the side of the pumpkin. By contrast, embodiments of the disclosure require only a single cut. The press characters are then individually placed into the cut portions of the pumpkin. When one half of the pumpkin is pressed into one set of posts extending from the characters, and another half of the pumpkin is pressed into the other set of posts extending from the other end of the characters, a pumpkin display is created. Intricate carving is not required. Simply spacing the press characters apart along the single pumpkin cut create contrast when a light source, such as a candle, is placed within the design. The result is a creative, quick, unique, simple, and safe lighted display.

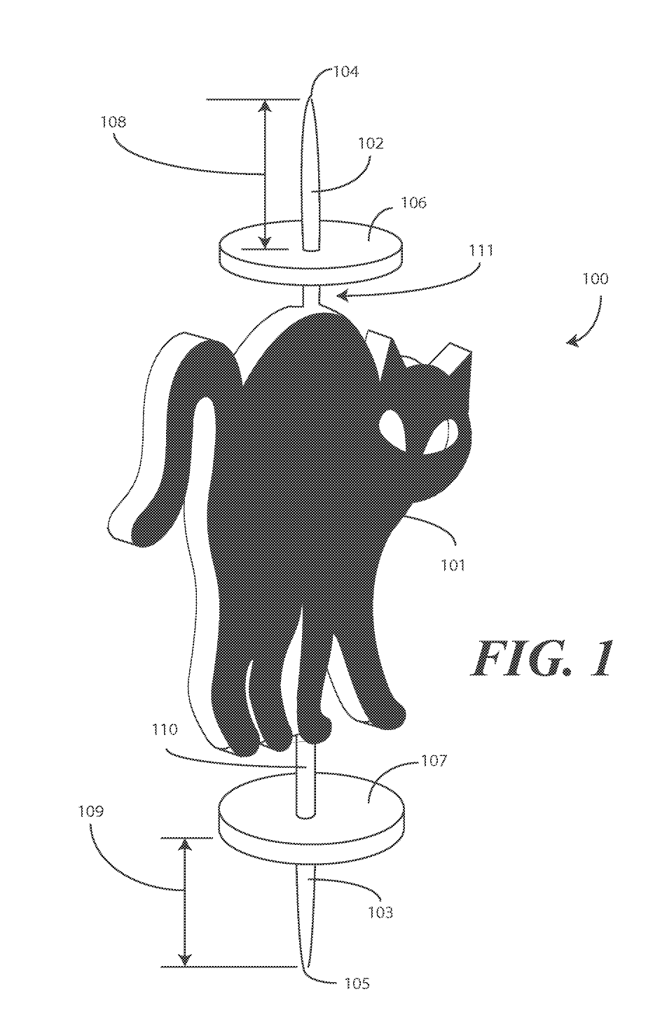

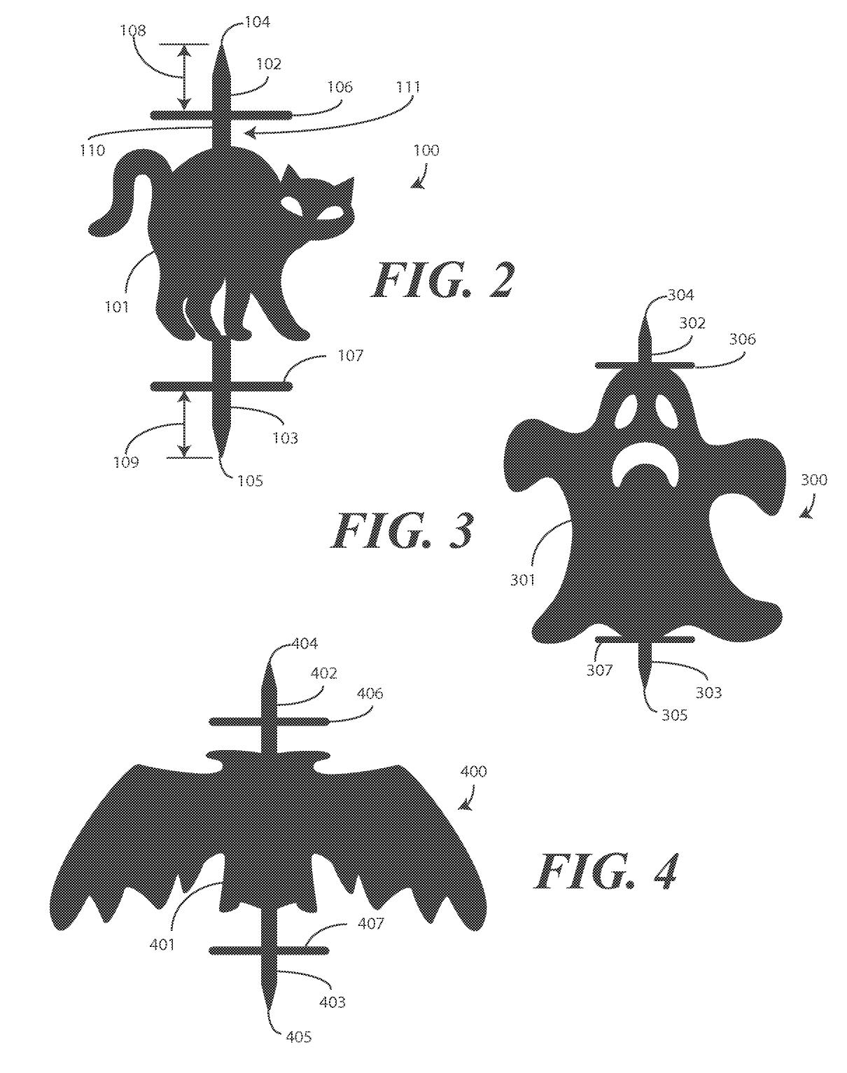

Turning now to FIGS. 1 and 2, illustrated therein is an explanatory press character 100 configured in accordance with one or more embodiments. FIG. 1 illustrates a perspective view of the press character 100, while FIG. 2 illustrates an elevation view of the press character.

The press character 100 includes a character portion 101, which in this embodiment is a cat. Two extensions, shown as posts 102,103 in FIG. 1, extend from a top of the character portion 101 and a bottom of the character portion 101, respectively. In one embodiment, the two posts 102,103 extend a distance 108 sufficient to retain the press character 100 securely fastened to an object, such as a pumpkin or watermelon, when the posts 102,103 are inserted into the object.

In one embodiment, the two posts 102,103 taper to respective tips 104,105. The tips 104,105 assist in allowing the posts 102,103 to insert into an object such as pumpkin flesh. In this embodiment, two discs 106,107 are coupled to the posts 102,103. The discs 106,107 are disposed between the tips 104,105 and the character portion 101. Where included, the discs 106,107 serve as mechanical stops to limit the distances 108,109 the posts 102,103 can be pressed and/or inserted into the object. In one embodiment, a space 111 is included between the discs 106,107 and the character portion 101. Including this space is optional.

In one embodiment, an optional axle 110 disposed between the posts 102,103 that allows the character portion 101 to spin freely between the posts 102,103. Accordingly, when the posts 102,103 are inserted into an object, such as pumpkin flesh, the character portion 101 is free to spin.

In one embodiment, the press character 100 is manufactured as a single, unitary component, with the character portion 101, the posts 102,103, and the discs 106,107 manufactured as a single part. For example, in one embodiment the press character 100 is handmade from any of a variety of materials, including plastic, metal, or wood. In another embodiment, the press character 100 is machine made from a material such as plastic, metal or wood. When made by machine, plastic could be injected into a mold in an injection molding process to allow for the simple, one-piece construction shown in FIGS. 1 and 2. In other embodiments, the press character 100 could be assembled from multiple pieces.

In one embodiment, the press character 100 is manufactured from a colored plastic using a custom mold in a machine manufacturing process. In another embodiment, they can be manufactured from different materials. For example, in one embodiment colored glass can be included for an added visual impact.

A cat is only one example of a character portion 101. The character portion 101 can be configured as other characters as well. For example, turning to FIG. 3, illustrated therein is another explanatory press character 300. The press character 300 of FIG. 3 has a character portion 301 that is configured as a ghost in keeping with the Halloween example provided in FIGS. 1 and 2. It should be noted that the press characters 100,300 can be configured as any number of characters for any number of holidays, seasons, or events. Illustrating by example, in another embodiment the character portion 301 can be configured and/or themed as a celebratory item for the Fourth of July. Since pumpkins are not traditionally served on the Fourth of July, it is contemplated that the press characters 100 can be inserted into objects other than pumpkins without departing from the spirit and scope of this disclosure. Continuing with the Fourth of July example, it is contemplated that press characters having character portions corresponding to the Fourth of July could be inserted into watermelons or other plants or vegetables.

As with the press character 100 of FIGS. 1 and, 2, the press character 300 of FIG. 3 includes two extensions, which are shown as posts 302,303. In this embodiment, the posts 302,303 extend from a top and bottom of the character portion 301, respectively. The two posts 302,303 taper to sharpened tips 304,305, which are suitable for allowing the posts 302,303 to be easily pressed into pumpkin flesh. In this embodiment, two discs 306,307 are provided. Where included, the discs 306,307 serve as mechanical stops to limit how far the posts 302,303 can be pressed into the pumpkin flesh. In one embodiment, the press character 300 is manufactured as a single component, with the character portion 301, the posts 302,303, and the discs 306,307 manufactured as a single part.

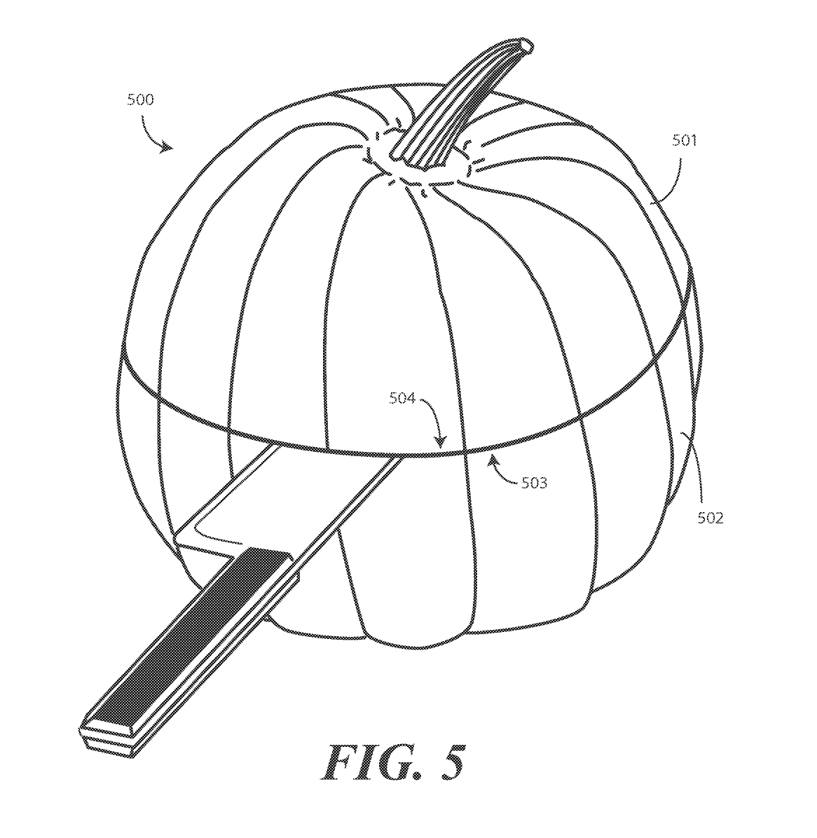

Turning to FIG. 4, illustrated therein is yet another explanatory press character 400. The press character 400 of FIG. 4 has a character portion 401 that is configured as a bat to provide yet another example suitable for use in decorating pumpkins for Halloween. As with the previously described press characters 100,300, the press character 400 of FIG. 4 includes two extensions, which are shown as posts 402,403. In this embodiment, the posts 402,403 extend from a top and bottom of the character portion 401, respectively. The two posts 402,403 taper to sharpened tips 404,405, which are suitable for allowing the posts 402,403 to be easily pressed into pumpkin flesh. In this embodiment, two discs 406,407 are provided. Where included, the discs 406,407 serve as mechanical stops to limit how far the posts 402,403 can be pressed into the pumpkin flesh. In one embodiment, the press character 400 is manufactured as a single component, with the character portion 401, the posts 402,403, and the discs 406,407 manufactured as a single part.

Turning now to FIGS. 5-9, illustrated therein is a method of creating a pumpkin display. Beginning with FIG. 5, a user cuts a pumpkin 500 (or watermelon or other object that will be transformed into a display) into two lobes 501,502. This is the only cutting step that is required to create a pumpkin display in accordance with embodiments of the disclosure. Once this is complete, the user separates the two lobes 501,502 and optionally removes the inner meat of the pumpkin 500 so that a light source can be placed therein.

From this point, the only components required to complete the pumpkin display are the press characters themselves. They interact only as far as how they are arranged on the pumpkin 500. The user has the freedom to customize how close or far they are placed from each other along the edges 503,504 of the lobes 501,502. As will be described below, this relationship, i.e., how far apart or close together each press character is, will affect how much light emanates from the light source disposed within the pumpkin 500.

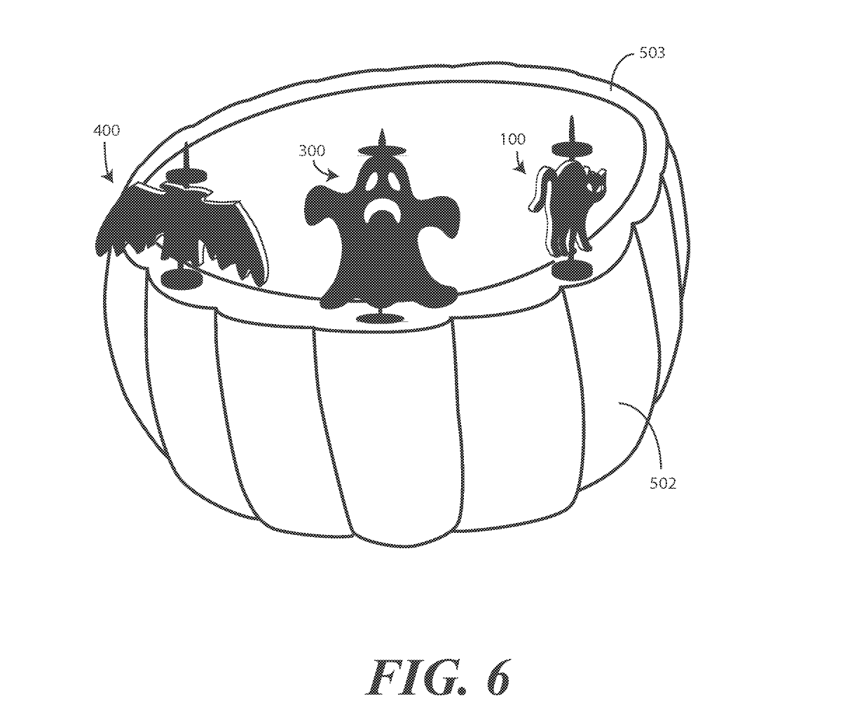

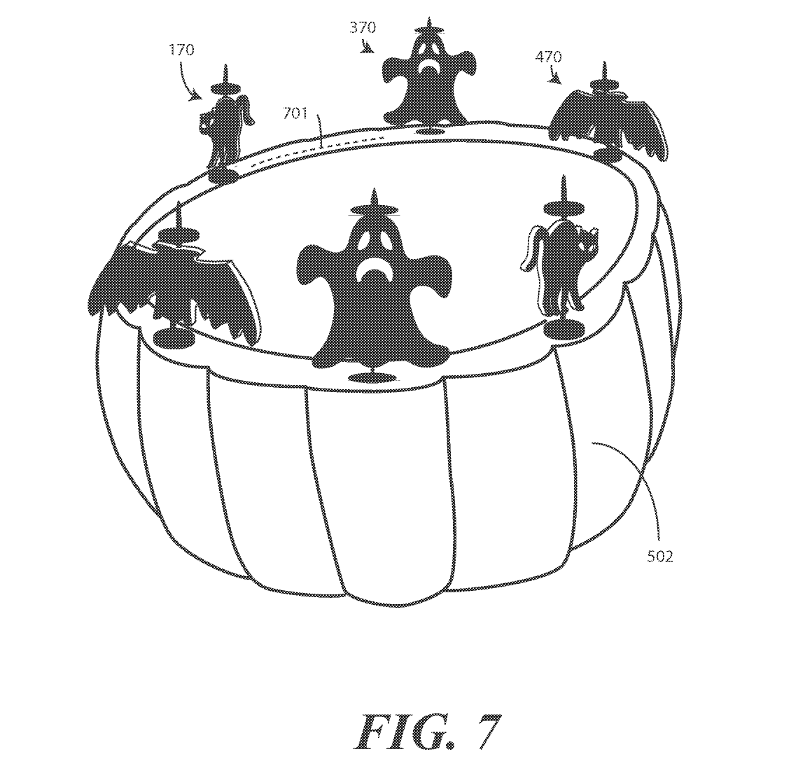

Turning to FIG. 6, the user the lightly presses a plurality of press characters 100,300,400 into an edge 503 of a lobe 502. In one embodiment, the press characters 100,300,400 are pressed into the edge 503 of the lobe 502 until their posts 103,303,403 go far enough into the edge 503 of the lobe 502 until the character portion 101,301,401 or the disc 107,307,407 sits flush with the edge 503 of the lobe 502. As shown in FIG. 7, additional press characters 170,370,470 are installed about the circumference 701 of the lobe 502. As noted above, the user has the freedom to choose how far apart or close together to space the press characters 170,370,470.

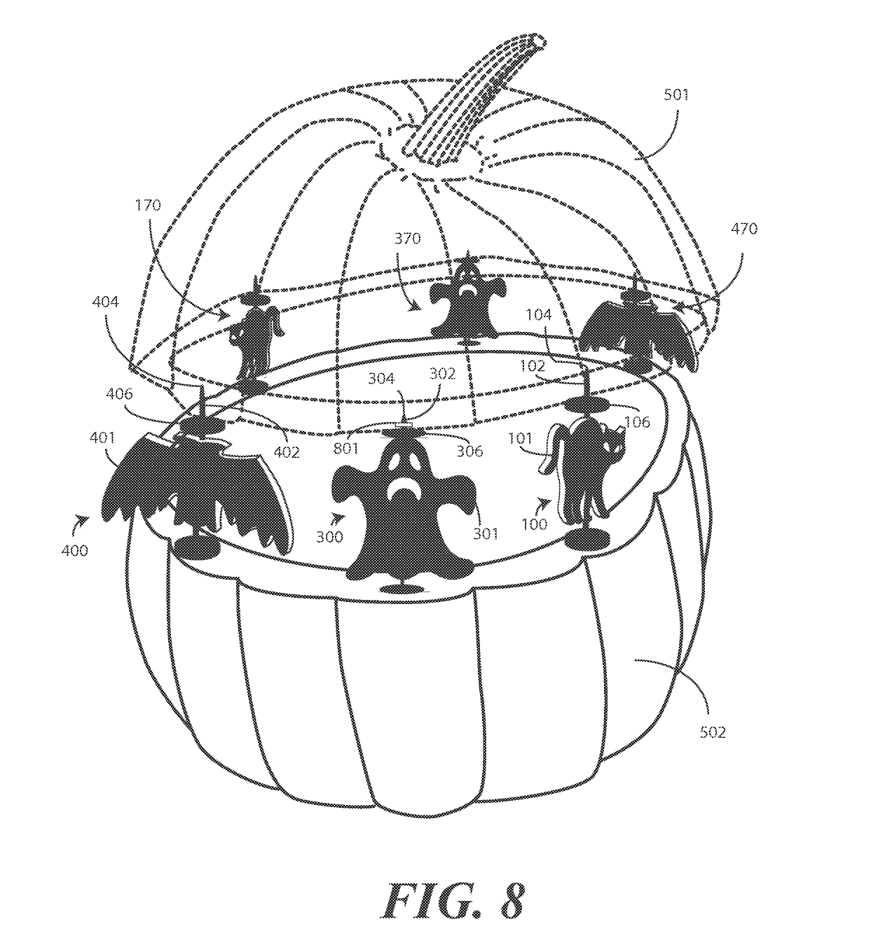

Turning to FIG. 8, the other lobe 501 is then pressed lightly toward the first lobe 502. This causes the sharpened tips 104,304,404, which are pointed as points in this embodiment, to penetrate the edge 504 of the other lobe 501. The posts 102,302,402 then press into the flesh of the other lobe 501. In one embodiment, the user may press the other lobe 501 toward the first lobe 502 into until the posts 102,302,402 go far enough into the edge 504 of the other lobe 501 that either the character portion 101,301,401 or the disc 106,306,406 sits flush with the edge 505 of the other lobe 501. The same action occurs with press characters 170,370,470 in one embodiment, as shown in FIG. 8. In one embodiment, a tooling anomaly 801 can be manufactured into the press characters, e.g., press character 300, to act as a stop to indicate the lobe 501 is flush.

The number of press characters used can vary. The six shown in FIGS. 7 and 8 are used for example only. In some embodiments three press characters can be used. In other embodiments fifteen press characters are used. These are examples only.

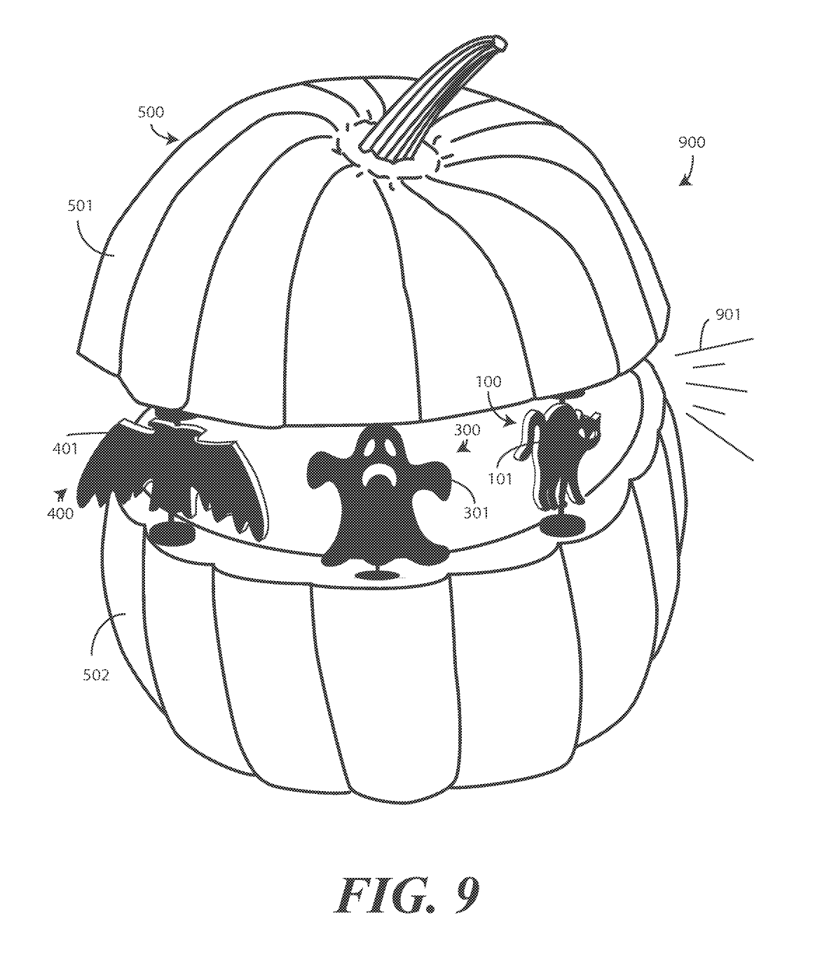

Turning now to FIG. 9, illustrated therein is the completed pumpkin display 900. When a light source is placed within the pumpkin 500, the spacing of the press characters 100,300,400 affects the amount of light 901 that emanates from the pumpkin display 900.

Embodiments of the disclosure contemplate that lighted pumpkin displays depend upon contrast to create the displayed effect. In the pumpkin display 900 of FIG. 9, the press characters 100,300,400 selectively block the light 901. This results in a silhouetting effect provided by the character portions 101,301,401. This silhouetting effect mimics the effect produced by a traditional carved pumpkin with a candle placed inside. When the press characters 100,300,400 are securely fastened to the pumpkin 500 by way of their posts 102,103,302,303,402,403 the character portions 101,301,401 are fixed (unless disposed on an axle 110 as described above). In either case, the character portions 101,301,401 selectively block light from a light source disposed within the pumpkin 500, thereby making the pumpkin display 900 appear to glow.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A press character, comprising:
a character portion;
a first post extending from a first end of the character portion; and
a second post extending from a second end of the character portion;
the first post and the second post tapering to points, respectively, the first post and the second post to insert into an object to attach the press character to the object.

2. The press character of claim 1, further comprising a disc coupled to one of the first post or the second post.

3. The press character of claim 2, further comprising another disc coupled to another of the first post or the second post.

4. The press character of claim 2, the disc a mechanical stop.

5. The press character of claim 4, the mechanical stop to limit a distances the one of the first post or the second post can insert into the object.

6. The press character of claim 1, the character portion, the first post, and the second post comprising a single part.

7. The press character of claim 6, the single part manufactured with a custom mold.

8. The press character of claim 1, the press character manufactured from plastic.

9. The press character of claim 1, the press character manufactured from metal.

10. The press character of claim 1, the press character comprising colored glass.

11. The press character of claim 1, the object comprising a pumpkin.

12. The press character of claim 1, the character portion defining one of a ghost, a cat, or a bat.

13. The press character of claim 1, the character portion themed for a Fourth of July holiday.

14. A method of creating a display, comprising:
inserting a first post of a press character into a lobe of an object;
inserting at least another post of another press character into the lobe; and
applying another lobe to insert a second post of the press character and at least another second post of the at least another press character into the another lobe.

15. The method of claim 14, further comprising placing a light source within the object.

16. The method of claim 15, further comprising employing character portions of each of the press character and the at least another press character to selectively block light.

17. The method of claim 16, further comprising splitting the object into the lobe and the another lobe.

18. The method of claim 14, the object comprising a watermelon.

19. A method of creating a pumpkin display, comprising:
splitting a pumpkin into a first lobe and a second lobe; and
placing a plurality of press characters along edges of the first lobe and the second lobe, respectively to form the pumpkin display.

20. The method of claim 19, further comprising illuminating the pumpkin.
